(19) United States
(12) Patent Application Publication
(10) Pub. No.: US 2025/0293744 A1
(43) Pub. Date: Sep. 18, 2025

(54) METHOD AND APPARATUS FOR CSI REPORTING FOR CRI-BASED CSI

(71) Applicant: SAMSUNG ELECTRONICS CO., LTD., Suwon-si (KR)

(72) Inventors: Ameha Tsegaye ABEBE, Suwon-si (KR); Seongmok LIM, Suwon-si (KR); Youngrok JANG, Suwon-si (KR); Hyoungju JI, Suwon-si (KR); Kyungjun CHOI, Suwon-si (KR)

(21) Appl. No.: 19/078,111

(22) Filed: Mar. 12, 2025

(30) Foreign Application Priority Data
Mar. 12, 2024 (KR) 10-2024-0034571

(51) Int. Cl. H04B 7/06; H04W 24/02

(52) U.S. Cl. CPC H04B 7/0626; H04B 7/0632; H04W 24/02

(57) ABSTRACT

The disclosure relates to a 5G or 6G communication system for supporting a higher data transmission rate. A method performed by a user equipment (UE) in a communication system is provided. The method comprises receiving, from a base station, information for N_{R} channel state information reference signal (CSI-RS) resources, identifying N sets of report quantities associated with N CSI-RS resources, where N≤N_{R}, identifying a channel state information (CSI) report including the N sets of report quantities, and transmitting the CSI report to the base station.

### CROSS-REFERENCE TO RELATED APPLICATIONS

This application is based on and claims priority under 35 U.S.C. § 119 to Korean Patent Application No. 10-2024-0034571 filed on Mar. 12, 2024, in the Korean Intellectual Property Office, the disclosure of which is incorporated by reference herein in its entirety.

### BACKGROUND

### 1. Field

The present disclosure relates to the field of 5th generation (5G) and beyond 5G communication networks and more particularly to channel state information (CSI) report for multiple network-energy saving hypotheses (e.g., adaptation patterns).

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The principal object of the disclosure herein is to disclose methods and apparatus for the network to configure CSI report configuration and the UE to report the CSI according to the network's configurations wherein the configurations correspond to multiple CSI-RS resource indices (CRIs)

The a yet another object of the disclosure herein is to disclose methods and apparatus for the UE to receive configuration information about CSI report configuration and the UE to report the CSI according to the network's configurations wherein the configurations correspond to multiple CSI-RS resource indices (CRIs)

As a yet another specific object of the disclosure herein is to disclose methods and systems for the network to configure the UE with CSI report configuration with report quantity set “cri-RI-PMI-CQI-LI” or “cri-RI-PMI-CQI” wherein the UE reports one or more sets of report quantities.

As a yet another specific object of the disclosure herein is to disclose methods and systems for the network to configure the UE with CSI report configuration for UE to report multiple sets of report quantities “cri-RI-PMI-CQI-LI” or “cri-RI-PMI-CQI” wherein the reported CQIs are reported in a differential manner.

The present disclosure has been made to address the above-mentioned problems and disadvantages, and to provide at least the advantages described below.

In one example, a method performed by a base station in a wireless communication system is provided; the method includes transmitting, to a terminal, configuration information about CSI configuration for the UE to report multiple sets of report quantities “cri-RI-PMI-CQI-LI” or “cri-RI-PMI-CQI.”

The present disclosure provides a method and apparatus for CSI reporting for CRI-based CSI.

In accordance with an aspect of the present disclosure, a method performed by a user equipment (UE) in a communication system is provided. The method comprises receiving, from a base station, information for N_{R} channel state information reference signal (CSI-RS) resources, identifying N sets of report quantities associated with N CSI-RS resources, where N≤N_{R}, identifying a channel state information (CSI) report including the N sets of report quantities, and transmitting the CSI report to the base station.

In accordance with another aspect of the present disclosure, a method performed by a base station in a communication system is provided. The method comprises transmitting, to a user equipment (UE), information for N_{R} channel state information reference signal (CSI-RS) resources, and receiving a channel state information (CSI) report from the UE. The CSI report includes N sets of report quantities, where N≤N_{R}, and the N sets of report quantities are associated with N CSI-RS resources.

In accordance with another aspect of the present disclosure, a user equipment (UE) in a communication system is provided. The UE comprises a transceiver, and at least one processor. At least one processor is configured to receive, from a base station, information for N_{R} channel state information reference signal (CSI-RS) resources, identify N sets of report quantities associated with N CSI-RS resources, where N≤N_{R}, identify a channel state information (CSI) report including the N sets of report quantities, and transmit the CSI report to the base station.

In accordance with another aspect of the present disclosure, a base station in a communication system is provided. The base station comprises a transceiver, and at least one processor. At least one processor is configured to transmit, to a user equipment (UE), information for N_{R} channel state information reference signal (CSI-RS) resources, and receive a channel state information (CSI) report from the UE. The CSI report includes N sets of report quantities, where N≤N_{R}, and the N sets of report quantities are associated with N CSI-RS resources.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 illustrates an example wireless network according to various embodiments of the present disclosure;

FIG. 2A illustrates an example wireless transmit and receive path according to various embodiments of the present disclosure;

FIG. 2B illustrates an example wireless receive path according to various embodiments of the present disclosure;

FIG. 3A illustrates an example UE according to various embodiments of the present disclosure;

FIG. 3B illustrates an example gNB according to various embodiments of the present disclosure;

FIG. 4 illustrates exemplary cross-polarized MIMO antenna system according to various embodiments of the present disclosure;

FIG. 5 illustrates exemplary layout for CSI-RS resource mapping in an OFDM time-frequency grid according to various embodiments of the present disclosure;

FIG. 6 illustrates an example of CSI report configurations and CSI measurement configurations that is supported in 5G NR system according to various embodiments of the present disclosure;

FIG. 7 illustrates exemplary procedure for non-PMI based CSI acquisition according to various embodiments of the present disclosure;

FIG. 8 illustrates the application of the parameter non-PMI-PortIndication according to various embodiments of the present disclosure;

FIG. 9 illustrates CRI indicating a CSI-RS resource associated with a specific analog beam according to various embodiments of the present disclosure;

FIG. 10 illustrates CRI indicating a CSI-RS resource associated with the best analog beam according to various embodiments of the present disclosure; and

FIG. 11 illustrates exemplary case for CRIs are reported with respect to the CRI indicating the best analog beam according to various embodiments of the present disclosure.

### DETAILED DESCRIPTION

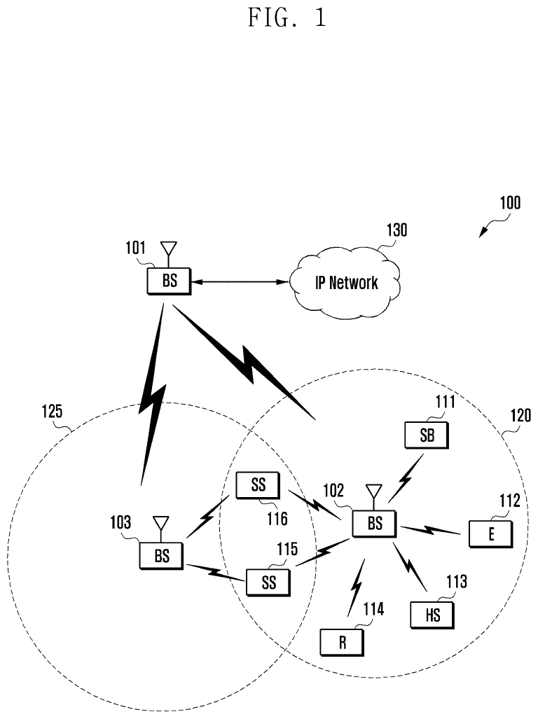

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHz, to enable robust coverage and mobility support. Aspects of the present disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large-scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, coordinated multi-points (COMP), reception-end interference cancellation and the like.

FIG. 1 illustrates an example wireless network 100 according to this disclosure. The embodiment of the wireless network 100 shown in FIG. 1 is for illustration only. Other embodiments of the wireless network 100 can be used without departing from the scope of this disclosure.

The wireless network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, the term “gNB” can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to equipment that wirelessly accesses a gNB. The UE could be a mobile device or a stationary device. For example, UE could be a mobile telephone, smartphone, monitoring device, alarm device, fleet management device, asset tracking device, automobile, desktop computer, entertainment device, infotainment device, vending machine, electricity meter, water meter, gas meter, security device, sensor device, appliance etc.

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, long-term evolution (LTE), LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of BS 101, BS 102 and BS 103 include 2D antenna arrays as described in embodiments of the present disclosure. In some embodiments, one or more of BS 101, BS 102 and BS 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

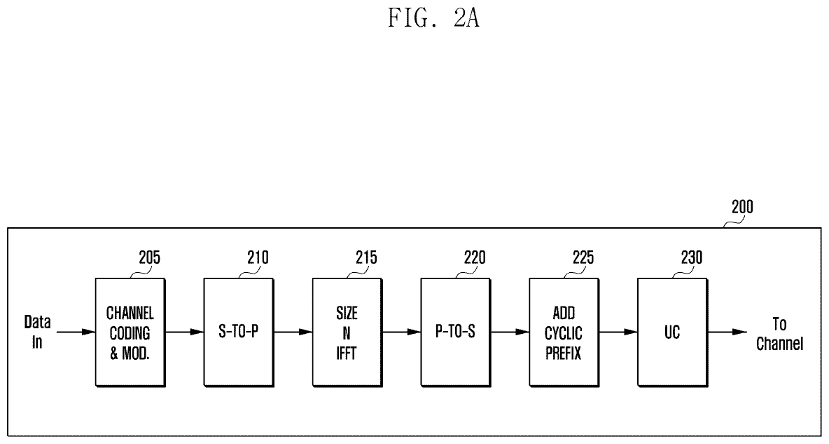

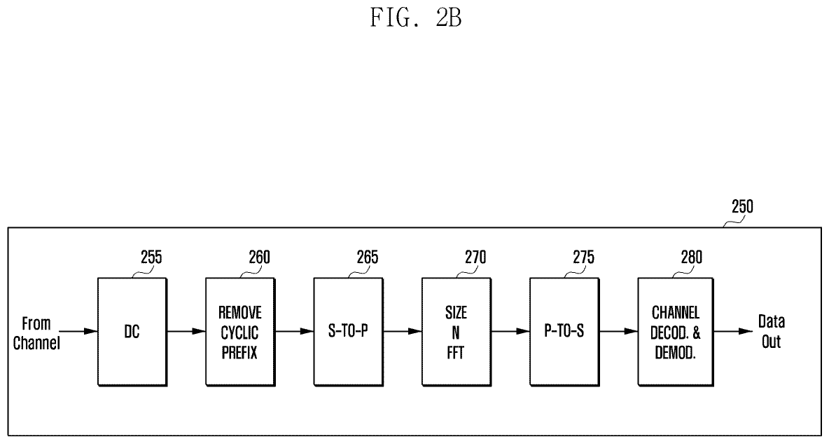

FIGS. 2A and 2B illustrate example wireless transmit and receive paths according to this disclosure. In the following description, a transmit path 200 may be described as being implemented in a gNB (such as a gNB 102), while a receive path 250 may be described as being implemented in a UE (such as UE 116). However, it will be understood that the receive path 250 can be implemented in a gNB and that the transmit path 200 can be implemented in a UE. In some embodiments, the receive path 250 is configured to support the codebook design and structure for systems having 2D antenna arrays as described in embodiments of the present disclosure.

The transmit path 200 includes a channel coding and modulation block 205, a serial-to-parallel (S-to-P) block 210, a size N inverse fast Fourier transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N fast Fourier transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as discrete Fourier transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

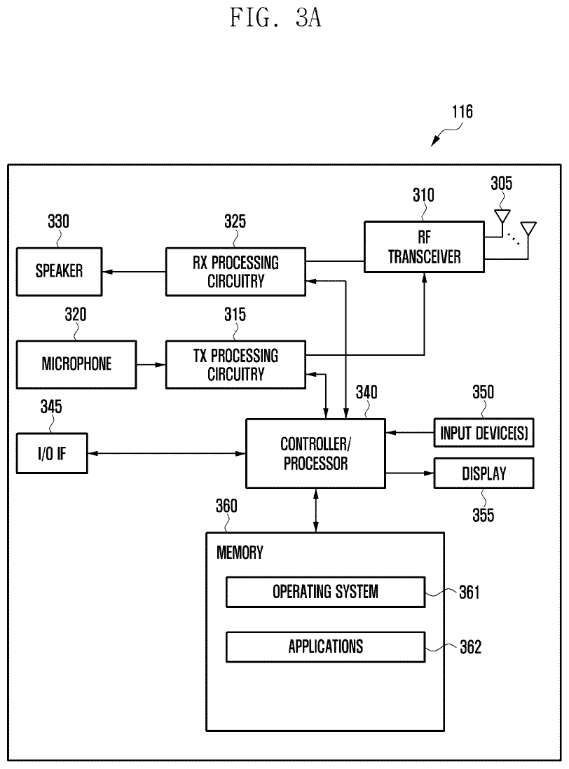

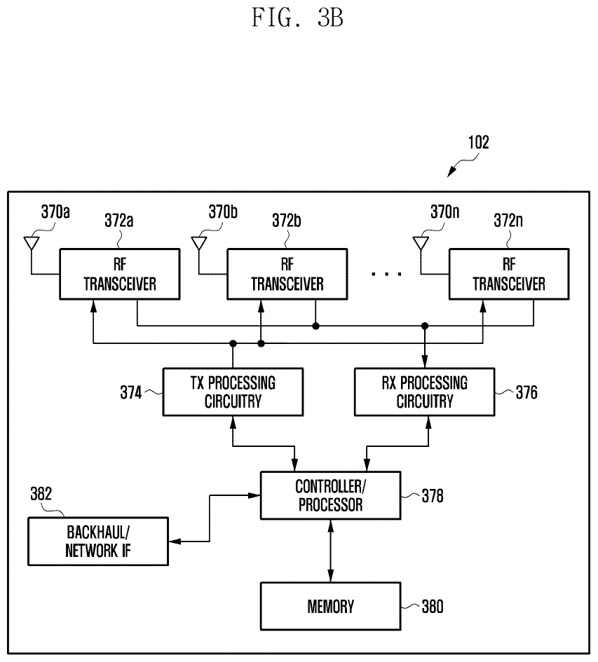

FIG. 3A illustrates an example UE 116 according to this disclosure. The embodiment of the UE 116 illustrated in FIG. 3A is for illustration only, and the UEs 111-115 of FIG. 1 can have the same or similar configuration. However, UEs come in a wide variety of configurations, and FIG. 3A does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the present disclosure as described in embodiments of the present disclosure. The main processor 340 can move data into or out of the memory 360 as required by an executing process. In some embodiments, the main processor 340 is configured to execute the applications 362 based on the OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include a random access memory (RAM), and another part of the memory 360 can include a Flash memory or other read-only memory (ROM).

Although FIG. 3A illustrates one example of UE 116, various changes may be made to FIG. 3A. For example, various components in FIG. 3A can be combined, further subdivided, or omitted and additional components can be added according to particular needs. As a particular example, the main processor 340 can be divided into multiple processors, such as one or more central processing units (CPUs) and one or more graphics processing units (GPUs). Also, while FIG. 3A illustrates the UE 116 configured as a mobile telephone or smartphone, UEs can be configured to operate as other types of mobile or stationary devices.

FIG. 3B illustrates an example gNB 102 according to this disclosure. The embodiment of the gNB 102 shown in FIG. 3B is for illustration only, and other gNBs of FIG. 1 can have the same or similar configuration. However, gNBs come in a wide variety of configurations, and FIG. 3B does not limit the scope of this disclosure to any particular implementation of a gNB. It is noted that the gNB 101 and the gNB 103 can include the same or similar structure as the gNB 102.

As shown in FIG. 3B, the gNB 102 includes multiple antennas 370a-370n, multiple RF transceivers 372a-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the present disclosure. In some embodiments, the controller/processor 378 supports communications between entities, such as web RTC. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 can support communications over any suitable wired or wireless connection(s). For example, when the gNB 102 is implemented as part of a cellular communication system (such as one supporting 5G, LTE, or LTE-A), the interface 382 can allow the gNB 102 to communicate with other gNBs over a wired or wireless backhaul connection. When the gNB 102 is implemented as an access point, the interface 382 can allow the gNB 102 to communicate over a wired or wireless local area network or over a wired or wireless connection to a larger network (such as the Internet). The interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) support communication with aggregation of FDD cells and TDD cells.

Although FIG. 3B illustrates one example of a gNB 102, various changes may be made to FIG. 3B. For example, the gNB 102 can include any number of each component shown in FIGS. 3A and 3B. As a particular example, an access point can include a number of interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

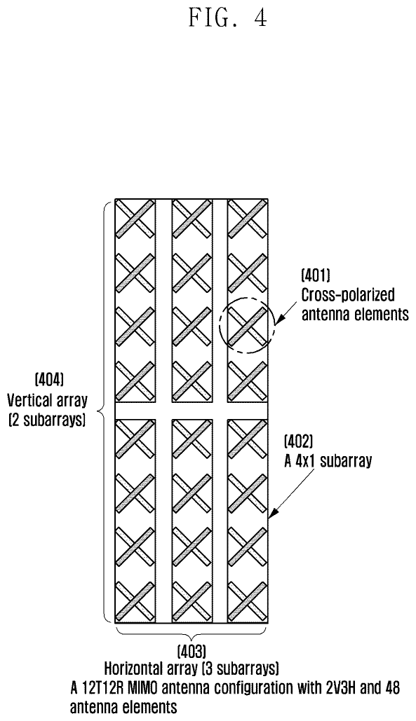

Multiple input multiple output (MIMO) system wherein a BS and/or a UE is equipped with multiple antennas has been widely employed in wireless systems for its advantages in terms of spatial multiplexing, diversity gain and array gain. FIG. 4 illustrates an example of MIMO antenna configuration with 24 antenna elements. In the figure, 4 cross-polarized (401) antenna elements form a 4×1 subarray (402). 12 subarrays form a 2V3H MIMO antennas configuration comprising 2 subarrays in vertical dimension (404) and 3 subarrays in horizontal dimension (403), respectively. Although FIG. 4 illustrates one example of MIMO antenna configuration, the present disclosure can be applied to various such configurations.

In MIMO systems, the channel state information (CSI) is required at the base station (BS) so that a signal from the BS is received at the UE with maximum possible received power and minimum possible interference. The acquisition of CSI at the BS can be via a measurement at the BS from an UL reference signal or via a measurement and feedback by the UE from a DL reference signal for time-domain duplexing (TDD) and frequency-domain duplexing (FDD) systems, respectively. In 5G FDD systems, the channel state information reference signal (CSI-RS) is the primary reference signal that is used by the UE to measure and report CSI.

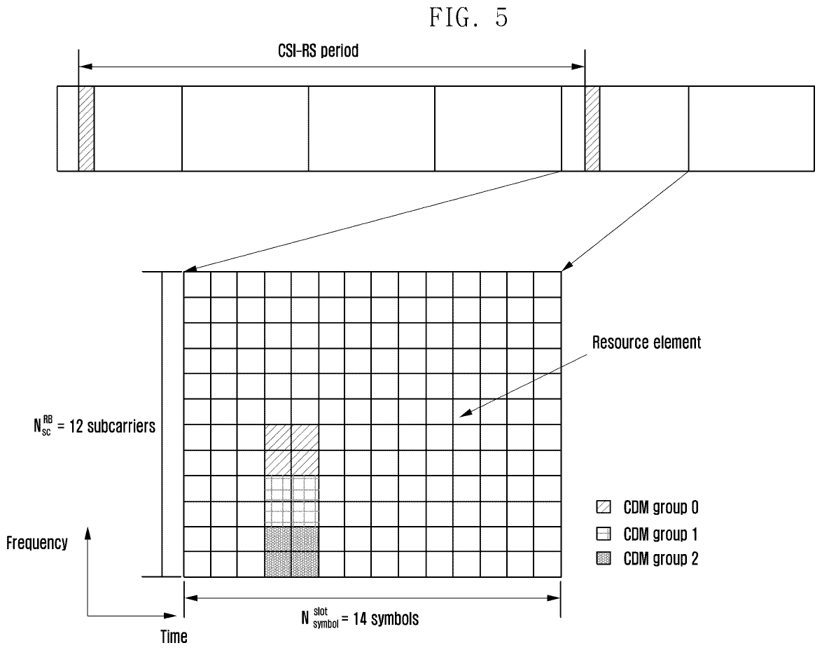

In some embodiments, a UE may receive a configuration signaling from a BS for a CSI-RS that can be used for channel measurement. An example of such configuration is illustrated in FIG. 5. In the figure, 12 antenna ports (CSI-RS ports) are mapped to a CSI-RS with 3 code-domain multiplexing (CDM) groups, wherein each CDM group is mapped to 4 resource elements (REs) in OFDM time-frequency grid. The antenna ports that are mapped to the same CDM group can be orthogonalized in code-domain by employing orthogonal cover codes. The CSI-RS configuration in FIG. 5 can be related to the MIMO antenna configuration in FIG. 4, by mapping a CSI-RS port to one of the polarization of a subarray. In the 5G N_{R} standards, three time-domain CSI-RS resources configurations, namely: periodic, semi-persistent and aperiodic are possible. In the figure, an illustrative example of periodic configuration is given with a period of 4 slots.

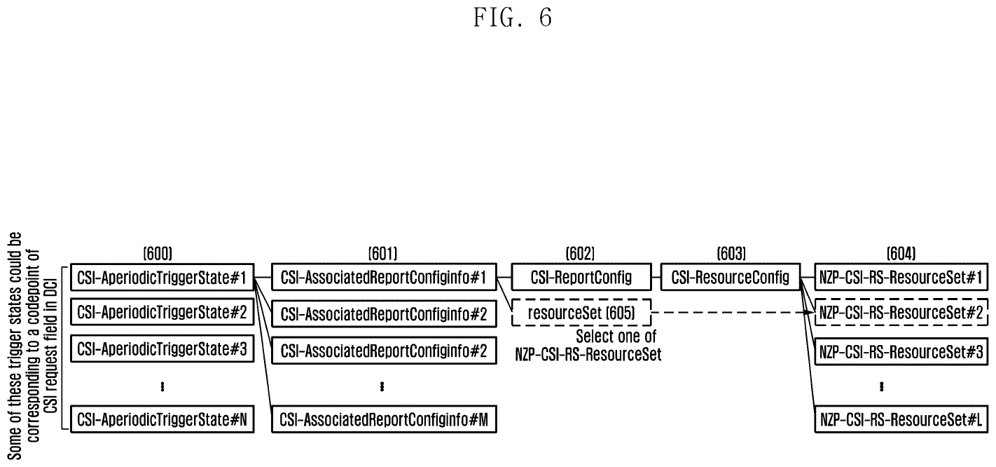

Moreover, a UE can be configured to measure a CSI feedback with a CSI report configuration. A CSI report configuration can be periodic, semi-persistent or aperiodic manner. FIG. 6 depicts the CSI report configuration and CSI measurement configurations that is supported in 5G N_{R} system. A CSI report configuration (602) can be linked to a CSI resource configuration (603). The CSI resource configuration (603) may contain one or more CSI resource sets (604) for channel measurement (CMR) or inference measurement (IMR).

In the case of periodic (P) and semi-persistent (SP) CSI report setting, the CSI resource configuration is associated with a single CSI resource set. In case of aperiodic (AP) CSI report, a UE can be configured with multiple CSI report triggering states (600). A CSI report triggering state is associated with one or more CSI associated report configuration information (601). A downlink control information (DCI) may include CSI request which indicates one of the configured triggering states. Moreover, the DCI with CSI request may also contain a resource set selection field (605) to select one of the resources sets (604).

Moreover, a CSI report can be configured with one of the CSI reporting quantities. This may include CSI resource indicator (CRI), the rank indicator (RI), precoding matrix indicator (PMI), channel quality indicator (CQI), layer indicator (LI), SINR, RSRP. In 5G N_{R}, various CSI reporting quantiles are adopted. In particular, an RRC parameter reportQuantity set to either “none,” “cri-RI-PMI-CQI,” “cri-RI-i1,” “cri-RI-i1-CQI,” “cri-RI-CQI,” “cri-RSRP,” “cri-SINR,” “ssb-Index-RSRP,” “ssb-Index-SINR,” “cri-RI-LI-PMI-CQI,” “cri-RSRP-Index,” “ssb-Index-RSRP-Index,” “cri-SINR-Index,” or “ssb-Index-SINR-Index.”

The CSI reporting can be used for transmission beam management (BM), specifically, in higher frequency bands, e.g., in frequency range 2 (FR2). In this case, the gNB may configure the UE to report one of the following quantities including, “cri-RSRP,” “cri-SINR,” “ssb-Index-RSRP,” “ssb-Index-SINR,” “cri-RSRP-Index,” “ssb-Index-RSRP-Index,” “cri-SINR-Index,” or “ssb-Index-SINR-Index.”

For a yet another purpose, the CSI report can be used for the downlink transmission CSI including “cri-RI-PMI-CQI,” “cri-RI-i1,” “cri-RI-i1-CQI,” or “cri-RI-CQI.”

The aforementioned CSI report may contain PMI when the configured reporting quantity is “cri-RI-PMI-CQI,” or “cri-RI-PMI-CQI-LI.”. On the other hand, the CSI report may not contain PMI when the configured reporting quantity is “cri-RI-CQI” which is commonly referred to as non-PMI-based CSI report.

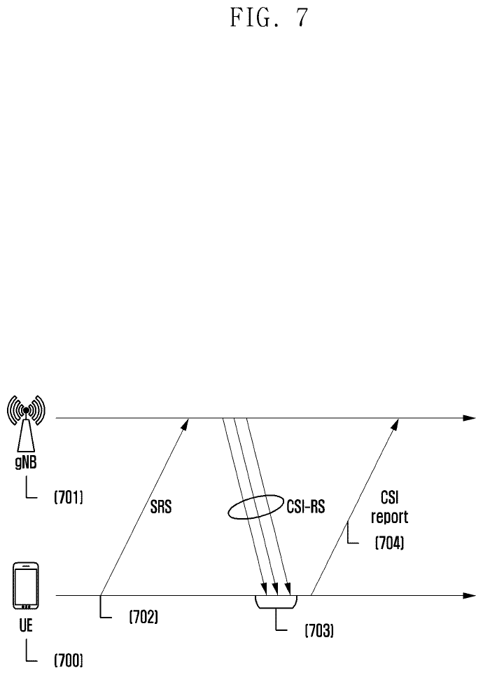

FIG. 7 illustrates exemplary procedure for non-PMI based CSI acquisition. Therein, the gNB (701) estimates the channel through uplink measurement, e.g., via SRS measurement (702). The gNB may then calculate precoder for one or more precoding hypothesis, wherein the precoding hypotheses may associate with different rank, different TRP, different analogue beam, etc. Then, the gNB precodes the CSI-RS resources with one or more precoders derived. The individual CSI-RS resources may correspond to transmissions by individual analogue beam or from individual TRP. Moreover, the CSI-RS ports in nonPMI-based CSI correspond to MIMO transmission layers. The gNB may precode the CSI-RS resources with different rank and precoding assumptions. For example, the gNB may precode an 8 ports CSI RS resources with multiple rank assumptions, e.g., for ank∈{1, 2, . . . , 8}. The port to MIMO layer mapping can be predefined or provided to the UE via higher layer parameter. After receiving the CSI-RS resources (703), a UE (700) may report CSI (704) with CSI reporting quantity cri-RI-CQI where the cri indicates the CSI-RS resource, RI indicates the UE's preferred rank and CQI indicates the corresponding channel quality information.

In 5G NR, the precoded CSI-RS ports to layer mapping can be configured explicitly via higher layer parameter non-PMI-PortIndication or derived a predefined mapping if this parameter is not configured.

In the legacy 5G NR, if the UE is configured with a CSI-ReportConfig with the higher layer parameter reportQuantity set to “cri-RI-CQI,” and if the UE is configured with higher layer parameter non-PMI-PortIndication contained in a CSI-ReportConfig, r ports are indicated in the order of layer ordering for rank r and each CSI-RS resource in the CSI resource setting is linked to the CSI-ReportConfig based on the order of the associated NZP-CSI-RS-ResourceId in the linked CSI resource setting for channel measurement given by higher layer parameter resourcesForChannelMeasurement. The configured higher layer parameter non-PMI-PortIndication contains a sequence p₀⁽¹⁾, p₀⁽²⁾, p₁⁽²⁾, p₀⁽³⁾, p₁⁽³⁾, p₂⁽³⁾, . . . , p₀^{(R)}, p₁^{(R)}, . . . p_{R-1}^{(R)}of port indices, where p₀^{(v)}, . . . , pᵥ₋₂^{(v)} are the CSI-RS port indices associated with rank v and R∈{1, 2, . . . , P} where P∈{1,2,4,8} is the number of ports in the CSI-RS resource. The UE may only report RI corresponding to the configured fields of PortIndexFor8Ranks.

If the UE is configured with a CSI-ReportConfig with the higher layer parameter reportQuantity set to “cri-RI-CQI,” and if the UE is not configured with higher layer parameter non-PMI-PortIndication, the UE assumes, for each CSI-RS resource in the CSI resource setting linked to the CSI-ReportConfig, that the CSI-RS port indices p₀^{(v)}, . . . , pᵥ₋₁^{(v)}={0, . . . , v−1} are associated with ranks v=1, 2, . . . , P where P∈{1,2,4,8} is the number of ports in the CSI-RS resource.

If the UE is configured with a CSI-ReportConfig with the higher layer parameter reportQuantity set to “cri-RI-CQI,” then when calculating the CQI for a rank, the UE may use the ports indicated for that rank for the selected CSI-RS resource. The precoder for the indicated ports may be assumed to be the identity matrix scaled by 1/\sqrt{v}.

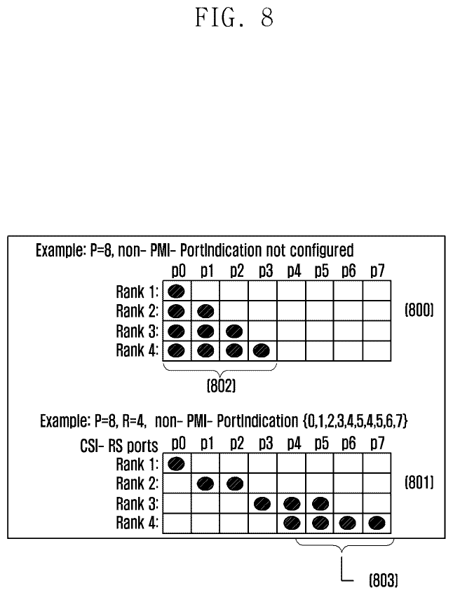

FIG. 8 illustrates exemplary cases for CSI ports to MIMO layers mapping when the higher layer parameter non-PMI-PortIndication is not configured (800) and is configured (801). CSI-RS with 8 ports is considered and layers mapping up to rank=4 is depicted. When the higher layer parameter non-PMI-PortIndication is not configured, the MIMO layers for each rank is mapped in ascending order from the first port. Thus, as illustrated in (800), the four layers for rank=4 hypothesis are mapped from the first to the fourth port. Whereas, when the higher layer parameter non-PMI-PortIndication is configured, e.g., non-PMI-PortIndication={0, 1, 2, 3, 4, 5, 4, 5, 6, 7}, the ports to layer mapping is depicted in (801). Thus, the four MIMO layers for rank=4 are mapped to the ports from 4 through 7 (803).

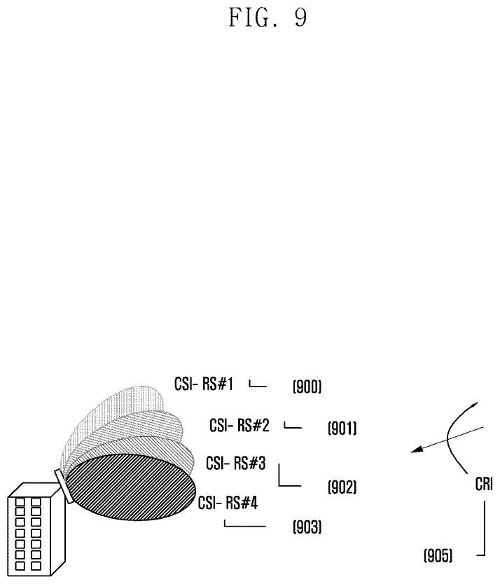

In the following, brief description is provided for hybrid-beamforming (HBF)-based CSI that can also be referred as CRI-based CSI. In CRI-based CSI, the UE can be configured with more than one CSI-RS resources for CSI measurement. In particular, the CSI-RS resources can be associated to different analog beamforming. FIG. 9 illustrates four CSI-RS resources CSI-RS #1 (900), CSI-RS #2 (901), CSI-RS #3 (902), and CSI-RS #4 (903) which are associated to four different analog beams. When the UE is configured with a CSI report quantity set to “cri-RI-PMI-CQI,” or “cri-RI-PMI-CQI-LI,” the UE may indicate the preferred analog beam by indicating the associated CSI-RS resource via a CSI-RS resource indicator (CRI) (905). The UE consequently determines other components of the CSI report, e.g., {RI, PMI, CQI, LI}, based on the reported CRI.

In the legacy CRI-based CSI report, the UE reports a single CRI and a set of RI, PMI, CQI and LI determined based on the reported CRI. In the case of multiple-users MIMO (MU-MIMO), the network can schedule UEs for the simultaneous reception of PDSCH, only if the users selected the same analog beam, i.e., CRI. Such scheduling restriction may impose performance degradation. One solution to alleviate the aforementioned restriction is to let the UE's multiple preferred analog beams (CRIs) and corresponding multiple sets of {RI, PMI, CQI, LI}. This gives the network more flexibility in terms of MU scheduling.

In the following, a multitude of methods is disclosed to enable a UE report multiple CRIs and corresponding multiple sets of {RI, PMI, CQI, LI}.

A description of example embodiments is provided on the following pages.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In this disclosure, the multiple analog beams for hybrid-beamforming (HBF)-based CSI is considered. The term “beam” is interchangeably used and may mean the same thing as CSI-RS resources, CRI, QCL Type D source RS to TCI state, or transmit filter. For example, reporting to N beams may be equivalent to reporting N CRIs.

### Free Selection of Analog Beams

In the following, multitude of embodiments of the present disclosure are listed wherein the UE reports multiple CRIs and multiple sets of corresponding CSI components.

### RRC Configured Number of CRIs.

Considering multiple analog beams, it may be beneficial if the network configures the UE to measure N_{R} CSI-RS resources and the UE reports CSI to all or just subset of CSI-RS resources. If the UE reports CSI for the subset of the CSI-RS resources, the UE may indicate the selected CSI-RS resources with N<N_{R} CRIs. It is also beneficial if the UE reported the CSI to indicate CSI-RS resources (beams) associated with the best channel quality, e.g., by comparing the CQI's corresponding the CSI-RS resources.

In one embodiment, Method 1.a.1, the network configures the UE with N_{R} CSI-RS resources in a CSI-RS resource set for measurement. The network may also configure the UE to report N∈{1, 2, . . . , N_{R}} CRIs via a higher layer parameter, e.g., numberOfCRI-report.

If the UE is configured to report N<N_{R} CRIs, the UE reports N CRIs and N sets of RI, PMI, CRI, CQI and/or LI.

If the UE is configured to report N=N_{R} CRIs, the UE may not report CRI. The UE may report N sets of RI, PMI, CRI, CQI and/or LI, wherein the first set is associated with the first CSI-RS resource, and the second set is associated with the second CSI-RS resource, and so on, in the CSI resource set.

If the higher layer parameter for the number of CRIs to report, i.e., numberOfCRI-report, is not configured, the UE may report N=1 set of CRI, RI, PMI, CQI and/or LI.

A reported CRI with codepoint “n−1” indicates the n-th CSI-RS resource in a CSI-RS resource set.

In another embodiment, Method 1.a.2, the network configures the UE with N_{R} CSI-RS resources in a CSI-RS resource set for measurement. The network may also configure the UE to report N∈{1, 2, . . . , N_{R}} CRIs via a higher layer parameter, e.g., numberOfCRI-report.

If the UE is configured to report N<N_{R} CRIs, the UE reports a combinatorial indicator to indicate N CRIs and N sets of RI, PMI, CRI, CQI and/or LI.

If the UE is configured to report N=N_{R} CRIs, the UE may not report CRI. The UE may report N sets of RI, PMI, CRI, CQI and/or LI, wherein the first set is associated with the first CSI-RS resource, and the second set is associated with the second CSI-RS resource, and so on, in the CSI resource set.

If the higher layer parameter for the number of CRIs to report, i.e., numberOfCRI-report, is not configured, the UE may report N=1 set of CRI, RI, PMI, CQI and/or LI.

A reported combinatorial indicator to indicate N CRIs indicates one of

$$n ∈ \{ 0 , 1 , 2 , … , ( \begin{matrix}{N}_{R} \\ N\end{matrix} ) - 1 \} where ( \begin{matrix}{N}_{R} \\ N\end{matrix} )$$

denotes the number of combinations for N choose N_{R}.

A UE dynamically selects number of CRIs.

In one embodiment, Method 1.b.1, the network configures the UE with N_{R} CSI-RS resources in a CSI-RS resource set for measurement. The UE may determine the number of CRIs to report, i.e., N≤N_{R}.

If the UE determines N<N_{R}, the UE indicates the determined N, and reports N CRIs and N sets of RI, PMI, CRI, CQI and/or LI.

A reported CRI with codepoint “n−1” indicates the n-th CSI-RS resource in a CSI-RS resource set.

In a yet another embodiment, Method 1.b.2, the network configures the UE with N_{R} CSI-RS resources in a CSI-RS resource set for measurement. The UE may determine the number of CRIs to report, i.e., N≤N_{R}.

If the UE determines N<N_{R}, the UE indicates the determined N, and reports N CRIs and N sets of RI, PMI, CRI, CQI and/or LI.

The UE indicates the determined N and the corresponding N CRIs where the N CRIs are indicated with a combinatorial indicator.

The UE reports the indicator to indicate the value of N where N∈{0, 1, 2, . . . , N_{R}−1} and a combinatorial indicator for the N CRI with an indicator

$$n ∈ \{ 0 , 1 , 2 , … , ( \begin{matrix}{N}_{R} \\ N\end{matrix} ) - 1 \} where ( \begin{matrix}{N}_{R} \\ N\end{matrix} )$$

denotes the number of combinations for N choose N_{R}.

In a yet another embodiment, Method 1.b.3, the network configures the UE with N_{R} CSI-RS resources in a CSI-RS resource set for measurement. The UE may determine the number of CRIs to report, i.e., N≤N_{R}.

If the UE determines N<N_{R}, the UE indicates the determined N, and reports N CRIs and N_{R} sets of RI, PMI, CRI, CQI and/or LI.

The UE indicates the determined N and the corresponding N CRIs with a unified indicator

A reported unified indicator to indicate the value of N and the corresponding N CRIs indicates one of

$$n ∈ \{ 0 , 1 , 2 , … , {\sum }_{N = 1}^{{N}_{R}} ( \begin{matrix}{N}_{R} \\ N\end{matrix} ) - 1 \} where ( \begin{matrix}{N}_{R} \\ N\end{matrix} )$$

denotes the number of combinations for N choose N_{R}.

A UE dynamically selects among a preconfigured number of CRIs.

In one embodiment, Method 1.c.1, the network configures the UE with N_{R} CSI-RS resources in a CSI-RS resource set for measurement and the candidate values for the number of CRIs for the UE to report, e.g., N_{R}−1 and N∈{2, 3}.

The UE then determines the value of N among preconfigured values.

### Restricted Selection of Analog Beams.

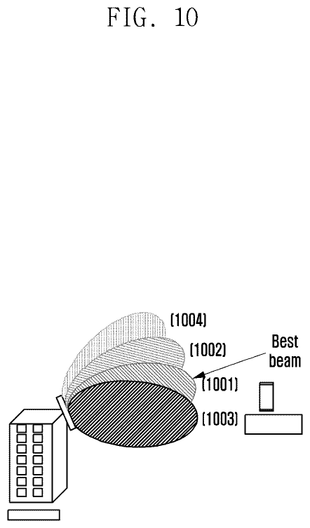

In some practical cases, only restricted analog beams may be relevant to the UE. FIG. 10 illustrates the aforementioned practical situation. As an example, only beams adjacent to the beam with maximum received power (1001), i.e., best beam, e.g., (1002) and (1003) are relevant. Conversely, the beams, which are angularly far apart from the “best beam,” e.g., (1004), may correspond to a very low receive power and thus can be referred as irrelevant beams. Thus, reporting CSI for irrelevant beams may unnecessarily cost the UE's computational and radio resources. To circumvent this issue and optimize the efficiency of CSI determination and reporting, some beam reporting restriction can be introduced.

In one embodiment, Method 2.1, the network configures the UE with N_{R} CSI-RS resources in a CSI-RS resource set for measurement. The network may also configure the UE to report N=2 CRIs via a higher layer parameter, e.g., numberOfCRI-report.

The UE reports two CRIs and two sets of {RI, PMI, CQI, LI}.

The first CRI n∈{0, 1, 2, . . . , N_{R}-1} indicates the best beam with codepoint “n−1” indicates the n-th CSI-RS resource in a CSI-RS resource set.

The second CRI n∈{0,1} with codepoint “0” indicates the n−1-th CSI-RS resource in a CSI-RS resource set where the n-th CSI-RS resource is the best beam indicated by the first CRI. Codepoint “1” indicates the n+1-th CSI-RS resource in a CSI-RS resource set where the n-th CSI-RS resource is the best beam indicated by the first CRI, or the vice versa.

In yet another embodiment, Method 2.2, the network configures the UE with N_{R} CSI-RS resources in a CSI-RS resource set for measurement. The network may also configure the UE to report N=3 CRIs via a higher layer parameter, e.g., numberOfCRI-report.

The UE reports a single CRI and up to three sets of {RI, PMI, CQI, LI}.

The first CRI n∈{0, 1, 2, . . . , N_{R}−1} indicates the best beam with codepoint “n−1” indicating the n-th CSI-RS resource in a CSI-RS resource set.

If the UE reports three sets of {RI, PMI, CQI, LI}, the first set corresponds to the reported CRI “n.” The second and third sets correspond to “n−1” and “n+1”-th CSI-RS resource in a CSI-RS resource set where the n-th CSI-RS resource is the best beam indicated by the first CRI.

If the UE reports two sets of {RI, PMI, CQI, LI}, the first set corresponds to the reported CRI “n.” If n=N_{R}−1, the second set of CSI component correspond to the n−1th CRI. If n=0, the second set of CSI component correspond to the n+1th CRI where the n-th CSI-RS resource is the best beam indicated by the first CRI.

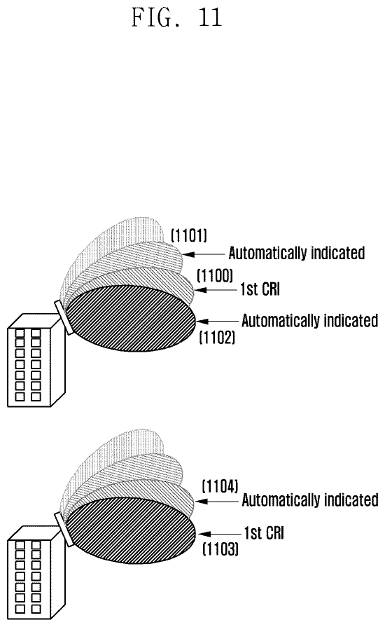

FIG. 11 illustrates the case in which gNB configures the UE with N_{R}=4 CSI-RS resources in a CSI-RS resource set for measurement and gNB configures the UE to report N=3 CRIs. In this particular example, (1100) is indicated by the reported CRI as the best beam. Thus, in accordance to one of the embodiments of this disclosure, the adjacent beams (1101) and (1102) are automatically mapped to the second and third set of {RI, PMI, CQI, LI}, respectively. For another exemplary case, wherein the reported CRI indicates index n=N_{R}−1 (1103), the beam n−1 (1104) is automatically indicated for the additionally reported set of {RI, PMI, CQI, LI}. For another exemplary case, wherein the reported CRI indicates index n=0, the beam n+1 is automatically indicated for the additionally reported set of {RI, PMI, CQI, LI}.

### CQI Reporting

Differential subband CQI reporting is configured.

The channel quality indicator (CQI) can be configured to be reported in various frequency granularities. As an example, the CQI can be configured to be reported in wideband manner wherein a single wideband CQI is reported. On the other hand, the UE may report CQI in subband manner wherein a UE reports CQI corresponding to each of configured subbands. 5G NR supports two ways to configure and report subband CQI based on whether higher layer parameter cqi-BitsPerSubband is configured or not.

If the higher layer parameter cqi-BitsPerSubband in CSI-ReportConfig is not configured, for each sub-band index s, a 2-bit sub-band differential CQI is defined as sub-band Offset level(s)=sub-band CQI index(s)−wideband CQI index. The UE reports wideband CQI index among the 16 wideband levels using 4 bits. Thus, the UE reports the subband CQI as a differential values with respect to the wideband CQI index. The codepoints of the reported sub-band differential CQI value ranging from 0 to 3 is interpreted as below:

| Sub-band differential CQI value | Offset level |
|---|---|
| 0 | 0 |
| 1 | 1 |
| 2 | ≥2 |
| 3 | ≤−1 |

If the higher layer parameter cqi-BitsPerSubband in CSI-ReportConfig is configured, for each sub-band index s, a 4-bit sub-band CQI is reported. The 4-bit sub-band CQI for each sub-band s is a CQI index in Table 1, Table 2, or Table 3 as configured by the higher layer parameter cqi-Table in CSI-ReportConfig.

TABLE 1
4-bit CQI Table 1

| | | | |
|---|---|---|---|
| CQI index | modulation | code rate × 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

TABLE 2
4-bit CQI Table 2

| | | | |
|---|---|---|---|
| CQI index | modulation | code rate × 1024 | efficiency |

| | |
|---|---|
| 0 | out of range |

| | | | |
|---|---|---|---|
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |

TABLE 3
4-bit CQI Table 3

| | | | |
|---|---|---|---|
| CQI index | modulation | code rate × 1024 | efficiency |

| | |
|---|---|
| 0 | out of range |

| | | | |
|---|---|---|---|
| 1 | QPSK | 30 | 0.0586 |
| 2 | QPSK | 50 | 0.0977 |
| 3 | QPSK | 78 | 0.1523 |
| 4 | QPSK | 120 | 0.2344 |
| 5 | QPSK | 193 | 0.3770 |
| 6 | QPSK | 308 | 0.6016 |
| 7 | QPSK | 449 | 0.8770 |
| 8 | QPSK | 602 | 1.1758 |
| 9 | 16QAM | 378 | 1.4766 |
| 10 | 16QAM | 490 | 1.9141 |
| 11 | 16QAM | 616 | 2.4063 |
| 12 | 64QAM | 466 | 2.7305 |
| 13 | 64QAM | 567 | 3.3223 |
| 14 | 64QAM | 666 | 3.9023 |
| 15 | 64QAM | 772 | 4.5234 |

TABLE 4
4-bit CQI Table 4

| | | | |
|---|---|---|---|
| CQI index | modulation | code rate × 1024 | efficiency |

| | |
|---|---|
| 0 | out of range |

| | | | |
|---|---|---|---|
| 1 | QPSK | 78 | 0.1523 |
| 2 | QPSK | 193 | 0.377 |
| 3 | QPSK | 449 | 0.877 |
| 4 | 16QAM | 378 | 1.4766 |
| 5 | 16QAM | 616 | 2.4063 |
| 6 | 64QAM | 567 | 3.3223 |
| 7 | 64QAM | 666 | 3.9023 |
| 8 | 64QAM | 772 | 4.5234 |
| 9 | 64QAM | 873 | 5.1152 |
| 10 | 256QAM | 711 | 5.5547 |
| 11 | 256QAM | 797 | 6.2266 |
| 12 | 256QAM | 885 | 6.9141 |
| 13 | 256QAM | 948 | 7.4063 |
| 14 | 1024QAM | 853 | 8.3301 |
| 15 | 1024QAM | 948 | 9.2578 |

In the following, a multitude of methods is introduced for CQI reporting configurations and reporting when the UE is configured to report multiple CRI in a CSI report configuration.

In one embodiment of the present disclosure, the UE is configured to report differential CQI for the reported with respect to an anchor CRI corresponding to the “best beam.”

In one embodiment, Method 3.a.1, the UE determines the anchor CRI for the best beam as the CRI corresponding to the highest calculated wideband CQI index.

As a yet another embodiment, Method 3.1.2, the UE determines the anchor CRI for the best beam as the CRI corresponding to the highest calculated value after summing the CQI indices across the sub-bands.

As a yet another embodiment, Method 3.a.2, when the UE is configured to report sub-band CQIs, e.g., when the higher layer parameter cqi-BitsPerSubband in CSI-ReportConfig is not configured,
when the UE is configured to report N sub-band CQIs for sub-band index “s” corresponding to N CRIs, or,
   when the UE dynamically determines to report N sub-band CQIs for sub-band index “s” corresponding to N CRIs,
the UE reports for the “n”-th sub-band CQI for sub-band index “s” corresponding to the “n”-th CRI with X-bit sub-band differential CQI,

Offset level (s,n′)=sub-band CQI index (s,n′)−wideband CQI index (n),
where wideband CQI index (n) is the wideband CQI reported to the best/anchor beam indicated by CRI index “n.”

As a yet another embodiment, Method 3.a.3, the gNB may indicate to the UE whether to report differential CQI across multiple CRIs with respect to the reported anchor/best CRI (beam), by higher layer parameter, e.g., differential-CQI-multipleCRI.

In Method 3.a.3, when the UE is configured to report differential subband CQI across subbands and across the reported CRIs, and when the UE reports N CRI's, the UE reports 1 wideband CQI and N subband CQIs for each of sub-band indices.

As a yet another embodiment, in Method 3.a.4, when the UE is configured to report sub-band CQIs, e.g., when the higher layer parameter cqi-BitsPerSubband in CSI-ReportConfig is not configured,
when the UE is configured to report N sub-band CQIs for sub-band index “s” corresponding to N CRIs, or,
   when the UE dynamically determines to report N sub-band CQIs for sub-band index “s” corresponding to N CRIs,
the UE reports for the “n”-th wide-band CQI corresponding to the “n”-th CRI with Y-bit, e.g., Y=2bits, wide-band differential CQI,

Offset wideband level (n′)=wideband CQI index (n′)−wideband CQI index (n),
where wideband CQI index (n) is the wideband CQI reported to the best/anchor beam indicated by CRI index “n.” In addition, the UE reports the sub-band CQI for the CRI index n′ with X-bit, e.g., X=2bits, sub-band differential CQI,

Offset level (s,n′)=sub-band CQI index (n′)−wideband CQI index (n′).

In Method 3.a.4, when the UE is configured to report differential subband CQI across subbands and across the reported CRIs, and when the UE reports N CRI's, the UE reports 1 wideband CQI, N−1 differential wideband CQI indices and N differential subband CQIs for each of the sub-band indices.

As a yet another embodiment, Method 3.a.5, when the UE is configured to report sub-band CQIs, e.g., when the higher layer parameter cqi-BitsPerSubband in CSI-ReportConfig is not configured,
when the UE is configured to report N sub-band CQIs for sub-band index “s” corresponding to N CRIs, or,
   when the UE dynamically determines to report N sub-band CQIs for sub-band index “s” corresponding to N CRIs,
the UE reports for the “n”-th wide-band CQI corresponding to the “n”-th CRI and the UE reports the sub-band CQI for the CRI index “n” with X-bit sub-band differential CQI as:

Offset level (s,n′)=sub-band CQI index (n′)−wideband CQI index (n′).

In Method 3.a.5, when the UE is configured to report differential sub-band CQI across sub-bands and when the UE is not configured to report differential CQI across the reported CRIs, if the UE reports N CRI's, the UE reports N wideband CQI and N differential sub-band CQIs for each of the sub-band indices.

Differential subband CQI against wideband CQI reporting is not configured.

In some cases, the CQI may vary greatly in the CSI reporting band, e.g., when the CSI reporting band is large. In this case, it may be preferable for the UE to report a standalone CQI for each sub-band, thus, the gNB may not configure the UE with differential sub-band reporting. However, the relationship or correlation in terms of CQI among the various beams can still be exploited, e.g., the UE may report differential subband CQI by anchoring on the best beam's subband CQI for the same subband index.

As one embodiment, Method 3.b.1, when the UE is not configured to report sub-band CQIs, e.g., when the higher layer parameter cqi-BitsPerSubband in CSI-ReportConfig is configured,
when the UE is configured to report N CRIs, or
   when the UE dynamically determines to report N CRIs,
the gNB may configure the UE to report sub-band CQI corresponding to N−1 CRIs via a higher layer parameter, e.g., differentialCQI-multiCRI-r19. For sub-band index “s,” the UE reports for the “n”-th suband-band CQI corresponding to the “n”-th CRI with Y-bit, e.g., Y=2 bits, sub-band differential CQI with respect to the sub-band CQI corresponding to the n-th CRI reported as “best beam,” i.e., the CRI corresponding to the highest value when the corresponding sub-band CQIs are summed/averaged.

sub-band offset level (s,n′)=sub-band CQI index (s,n′)−sub-band CQI index (s,n).

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving, from a base station, information for N_{R} channel state information reference signal (CSI-RS) resources;
identifying N sets of report quantities associated with N CSI-RS resources, where N≤N_{R};
identifying a channel state information (CSI) report including the N sets of report quantities; and
transmitting the CSI report to the base station.

2. The method of claim 1, wherein a set of report quantities includes at least one of a CSI-RS resource indicator (CRI), a rank indicator (RI), a precoding matrix indicator (PMI), or a channel quality indicator (CQI).

3. The method of claim 1, wherein a value of N is configured via a higher layer signaling.

4. The method of claim 1, wherein a value of N is selected by the UE.

5. The method of claim 1, wherein the N_{R} CSI-RS resources are associated with a same CSI-RS resource set.

6. A method performed by a base station in a communication system, the method comprising:
transmitting, to a user equipment (UE), information for N_{R} channel state information reference signal (CSI-RS) resources; and
receiving a channel state information (CSI) report from the UE,
wherein the CSI report includes N sets of report quantities, where N≤N_{R}, and
wherein the N sets of report quantities are associated with N CSI-RS resources.

7. The method of claim 6, wherein a set of report quantities includes at least one of a CSI-RS resource indicator (CRI), a rank indicator (RI), a precoding matrix indicator (PMI), or a channel quality indicator (CQI).

8. The method of claim 6, wherein a value of Nis configured via a higher layer signaling.

9. The method of claim 6, wherein a value of N is selected by the UE.

10. The method of claim 6, wherein the N_{R} CSI-RS resources are associated with a same CSI-RS resource set.

11. A user equipment (UE) in a communication system, the UE comprising:
a transceiver; and
at least one processor configured to:
receive, from a base station, information for N_{R} channel state information reference signal (CSI-RS) resources,
identify N sets of report quantities associated with N CSI-RS resources, where N≤N_{R},
identify a channel state information (CSI) report including the N sets of report quantities, and
transmit the CSI report to the base station.

12. The UE of claim 11, wherein a set of report quantities includes at least one of CSI-RS resource indicator (CRI), rank indicator (RI), precoding matrix indicator (PMI), or channel quality indicator (CQI).

13. The UE of claim 11, wherein a value of N is configured via a higher layer signaling.

14. The UE of claim 11, wherein a value of N is selected by the UE.

15. The UE of claim 11, wherein the N_{R} CSI-RS resources are associated with a same CSI-RS resource set.

16. A base station in a communication system, the base station comprising:
a transceiver; and
at least one processor configured to:
transmit, to a user equipment (UE), information for N_{R} channel state information reference signal (CSI-RS) resources, and
receive a channel state information (CSI) report from the UE,
wherein the CSI report includes N sets of report quantities, where N≤N_{R}, and
wherein the N sets of report quantities are associated with N CSI-RS resources.

17. The base station of claim 16, wherein a set of report quantities includes at least one of a CSI-RS resource indicator (CRI), a rank indicator (RI), a precoding matrix indicator (PMI), or a channel quality indicator (CQI).

18. The base station of claim 16, wherein a value of N is configured via a higher layer signaling.

19. The base station of claim 16, wherein a value of N is selected by the UE.

20. The base station of claim 16, wherein the N_{R} CSI-RS resources are associated with a same CSI-RS resource set.
